(19) United States
(12) Patent Application Publication
(10) Pub. No.: US 2014/0083879 A1
(43) Pub. Date: Mar. 27, 2014

(54) CUTTING AND DISPENSING CLOSURES

(71) Applicant: David C. Ulstad, Dublin, OH (US)

(72) Inventor: David C. Ulstad, Dublin, OH (US)

(73) Assignee: ABBOTT LABORATORIES, ABBOTT PARK, IL (US)

(21) Appl. No.: 14/009,811

(22) PCT Filed: Apr. 3, 2012
(86) PCT No.: PCT/US12/31966

§ 371 Date: Dec. 12, 2013

Related U.S. Application Data
(60) Provisional application No. 61/472,404, filed on Apr. 6, 2011.
(60) Provisional application No. 61/482,747, filed on May 5, 2011.

(51) Int. Cl. B65D 51/22; A61J 9/00; B65D 51/28

(52) U.S. Cl. CPC B65D 51/22; B65D 51/2835; A61J 9/008
USPC 206/222; 220/258.4; 215/11.1

(57) ABSTRACT

A closure (100) for a container (110) includes a stationary member (200) having an inner surface (210) and an outer surface (220), the inner surface is configured to be secured to an outer circumference (150) of a neck (130) of the container at a first inner portion (215) having a first set of threads (218) and includes a second inner portion (225) having a second set of screw threads (230), the outer surface includes a third set of screw threads (320). A substantially cylindrical cap member (270) includes a top (280) and a sidewall (290) that extends downward from an outer circumference of the top, the sidewall includes sidewall threads for rotational engagement with the third set of screw threads of the stationary member. A cutting member (330) includes outer threads (340) located on an outer circumference of the cutting member and an engagement member (360) located on an inner circumference of the cutting member. The cylindrical cap is configured to move the cutting member in an opposite longitudinal direction to the cylindrical cap upon opening rotation of the cylindrical cap.

### CROSS REFERENCE TO RELATED APPLICATIONS

This application claims priority to U.S. Provisional Applications Nos. 61/472,404 filed Apr. 6, 2011, and 61/482,747 filed May 5, 2011, the disclosures of which are hereby incorporated by reference in their entireties.

### FIELD OF THE DISCLOSURE

The present disclosure relates generally to closures for containers, such as plastic disposable containers. More particularly, the present disclosure relates generally to closures for containers adapted to cut a sealing membrane, such as a sealing film, and dispense the contents of the container.

### BACKGROUND OF THE DISCLOSURE

Infant nutritionals, adult and medical nutritionals, sport nutritionals, energy drinks, soft drinks, and the like often times are provided in plastic bottles or other disposable containers. The bottles are typically sealed after being filled with a product to prevent product degradation and/or contamination of the product. Foil seals may be particularly desirable for products that are aseptically processed.

Sealing film, such as foil or plastic film, commonly referred to as “seals,” is generally considered the most robust form of a sealing closure for plastic bottles. Consumers, however, often prefer direct seal screw caps over seals because the seals typically require three steps to open (i.e., removal of the plastic cap, removal of the seal and disposal of the seal). Additional steps may be required if the seal tears in an unexpected manner during removal. Such unexpected and undesired tearing of the seal can lead to frustration by the user, spilling of the contents of the bottle or foil scrap entering the bottle and contaminating the contents. Accordingly, there is an unmet need for a convenient closure that remedies existing issues with sealed bottles

### SUMMARY OF THE DISCLOSURE

The present disclosure is directed to closures for various types of containers, including plastic and glass containers. The closures described herein are capable of cutting a sealing membrane, such as a foil membrane, of a container to allow the contents of the container to be dispensed to a user. In some embodiments, the described closures may additionally provide a secondary sealing function after the sealing membrane has been cut. In one specific embodiment, the closure is suitable for cutting both a first and second sealing membranes such that an additive, held between the membranes, can be released and introduced into the contents of the container.

In one aspect of the present disclosure, a closure for a container includes a stationary member having an inner surface and an outer surface, the inner surface is configured to be secured to an outer circumference of a neck of the container at a first inner portion and including a second inner portion having a second set of screw threads, the outer surface comprising a third set of screw threads. A substantially cylindrical cap member includes a top wall and a sidewall that extends downward from an outer circumference of the top wall, the sidewall includes sidewall threads for rotational engagement with the third set of screw threads of the stationary member. A cutting member includes an outer set of threads located on an outer circumference of the cutting member and an engagement member is located on an inner circumference of the cutting member. The cylindrical cap is configured to move the cutting member in an opposite longitudinal direction to the cylindrical cap upon application of an opening rotation to the cylindrical cap.

In another aspect of the present disclosure, a closure for a container having a threaded neck includes a first sealing membrane for sealing an open end of a container and a second membrane, adjacent the first sealing membrane, containing an additive to be added to the container. A cylindrical body member has a first end, a second end opposite the first end, an inner surface and an outer surface, the inner surface includes a set of screw threads, the first end and the second end are open. A cutting member has a first set of threads on its outer surface, and is configured for threaded engagement with the inner surface of the cylindrical body member. The cutting member is configured to cut the first sealing membrane and the second membrane upon rotation of the cutting member.

### BRIEF DESCRIPTION OF THE DRAWINGS

The objects, features and advantages of the present disclosure will become more apparent from a reading of the following description in connection with the accompanying drawings.

FIG. 1 is a perspective view of a closure according to a first embodiment.

FIG. 2 is section of the closure shown in FIG. 1 taken in the plane of the line 2-2 of FIG. 1.

FIG. 3 is an expanded view of the closure shown in FIG. 2.

FIG. 4 is a front elevation view of a closure according to another embodiment.

FIG. 5 is a section view of the closure shown in FIG. 4 taken in the plane of the line 5-5 of FIG. 4.

FIG. 6 is an expanded view of the closure shown in FIG. 4.

FIG. 7 is a partial section view of the closure shown in FIG. 4 taken in the plane of the line 5-5 of FIG. 4.

### DETAILED DESCRIPTION OF THE EMBODIMENTS

The present disclosure provides closures for various types of bottles and containers. The closures described herein are capable of cutting at least one sealing membrane, such as a foil membrane, to allow the contents of the bottle or container to be dispensed. The present disclosure provides a solution to the longstanding problem of removing a sealing member of a container in a healthy, sanitary way in a single step without spillage of the contents of the container or contaminating the contents. The closures described herein accomplish this through a unique cutting action that allows instant access to the contents of the container after the closure is removed.

For the purposes of promoting an understanding of the principles of the present disclosure, reference will now be made to embodiments and specific language will be used to describe the same. It will nevertheless be understood that no limitation of the scope of the claims is thereby intended, such alteration and further modifications of the readings of the disclosure as illustrated herein, being contemplated as would normally occur to one skilled in the art to which the disclosure relates.

Articles “a” and “an” are used herein to refer to one or to more than one (i.e. at least one) of the grammatical object of the article. By way of example, “an element” means at least one element and can include more than one element.

Unless otherwise defined, all technical terms used herein have the same meaning as commonly understood by one of ordinary skill in the art to which this disclosure belongs.

The present disclosure describes closures for containers that may provide functionality to cut a sealing membrane of a container and provide a secondary sealing function after the sealing membrane has been cut. The containers may be generally any suitable packaging for containing substances including, without limitation, glass or plastic bottles, plastic containers, bags or pouches constructed of films or other plastics, and other suitable packaging. The term “sealing membrane” refers to a single or multi-layer film, foil, paper, plastic, thermoplastic, laminate, other sealing layer or combinations thereof that is used to seal a substance within a container. In some embodiments, the sealing membrane may be used to hermetically or aseptically seal the container that includes a liquid.

The containers disclosed herein may be suitable for use with nutritional substances. As used herein the term “substance” may refer to a liquid product, a semi-liquid product, or powder product. The term “liquid product” means a product that is a flowable non-solid product including, for example but not limited to, aqueous solutions, solutions having a determinable viscosity, emulsions, colloids, pastes, gels, dispersions and other flowable non-solid products so as to exclude solid products such as bars and particulate products, such as powders.

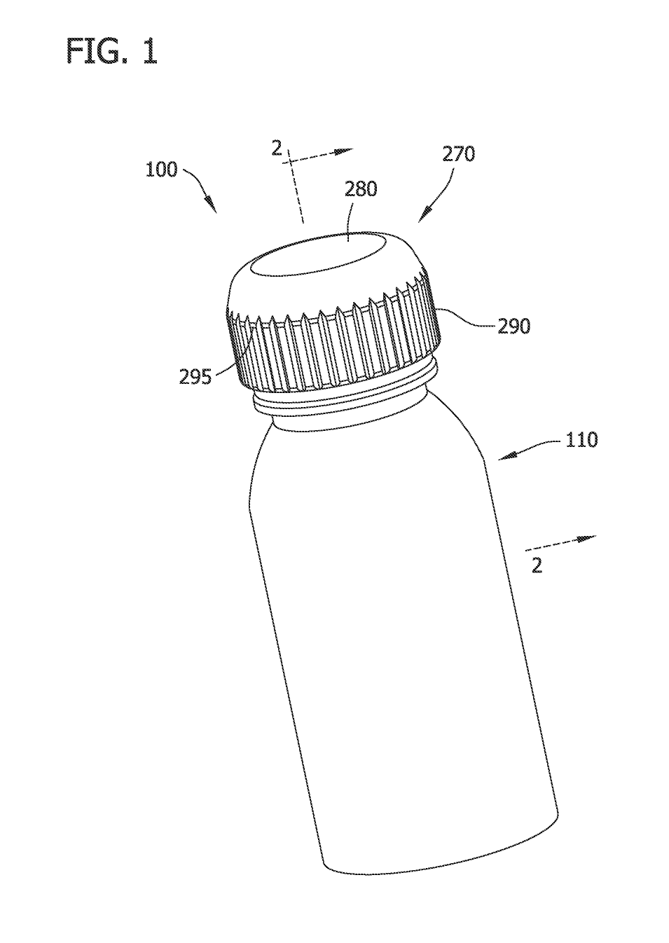

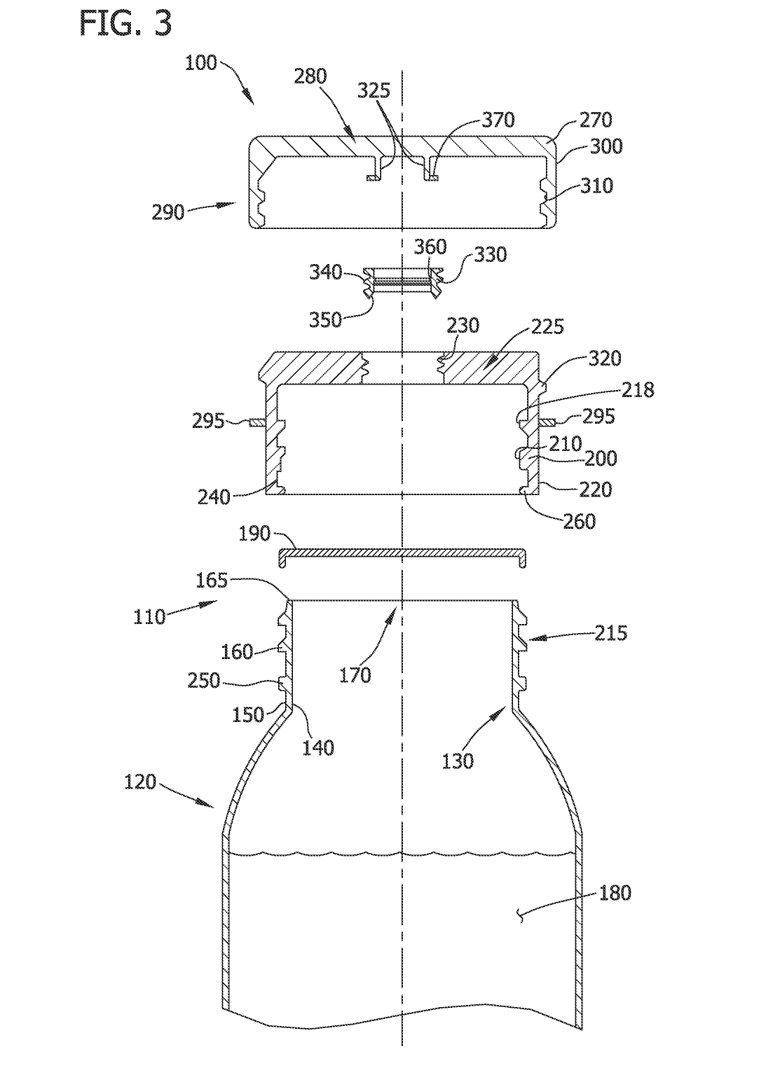

FIGS. 1-3 show a closure 100 according to a first embodiment. Closure 100 is adapted to close a container 110. Container 110 comprises a body 120 and a neck 130. Neck 130 has an inner surface 140 and an outer surface 150 that is radially outward from inner surface 140. In one embodiment, neck 130 is generally cylindrical in shape, and container 110 is symmetric about longitudinal axis C. In other embodiments, container 110 may be non-symmetric, or symmetric about one or more axis. Container 110 may be any shape that allows the closures to function as described herein. Outer surface 150 includes a set of threads 160. Set of threads 160 may include one or more threads that helically wrap around outer surface 150. Inner surface 140 and outer surface 150 connect at a rim 165 defining bottle opening 170. Container 110 may contain a substance 180, which is a liquid substance.

After filling container 110 with substance 180, a sealing membrane 190 is sealingly coupled to rim 165 to seal opening 170. Sealing membrane 190 may be coupled to rim 165 by way of an adhesive, sonic welding, heat sealing or any other manner of sealing that allows the closure to function as described herein. In one embodiment, sealing membrane 190 overhangs rim 165 and contacts at least a portion of outer surface 150. In another embodiment, sealing member 190 is sized such that an outer circumference of the sealing membrane 190 is coextensive with a circumference of rim 165.

In the present embodiment, a stationary member 200 is configured to be coupled to neck 130 by threaded engagement with threads 160. Stationary member 200 has an inner surface 210 and an outer surface 220. Inner surface 210 has a first portion 215 including a set of threads 218 that are sized for engagement with threads 160. Inner surface 210 has a second portion 225 that is disposed above first portion 210. As used herein the terms “above” and “below” refer to vertical references when the container 110 is in an upright orientation. Second portion 225 includes a second set of threads 230. In one embodiment, second portion 225 has an inner diameter less than or equal to an inner diameter of rim 165. In one embodiment, to secure stationary member to container 110, a ratchet member 240 may be provided on inner surface 210. In this embodiment, ratchet member 240 is ramp-shaped such that upon a closing rotation of stationary member 200 on neck 130, the ratchet member 240 slides over a locking protrusion 250. Locking protrusion may be rectangular, square, ramp shaped or the like for uni-directional engagement with ratchet member 240. Ratchet member 240 may be shaped similar to a tamper evidencing band (i.e., a band having a plurality of ramp shaped protrusions formed on an inner surface thereof), but securely attached to stationary member 200, without the use of lateral cuts that typically allow a tamper band to break away during an initial opening. Upon closing rotation of stationary member 200 on neck 130, ratchet members 240 engage with protrusion 250 which prevents stationary member 200 from counter-rotation and removal. In another embodiment, ratchet member 240 has a flange 260 that abuts protrusion 250 to lock stationary member 200 in position on neck 130.

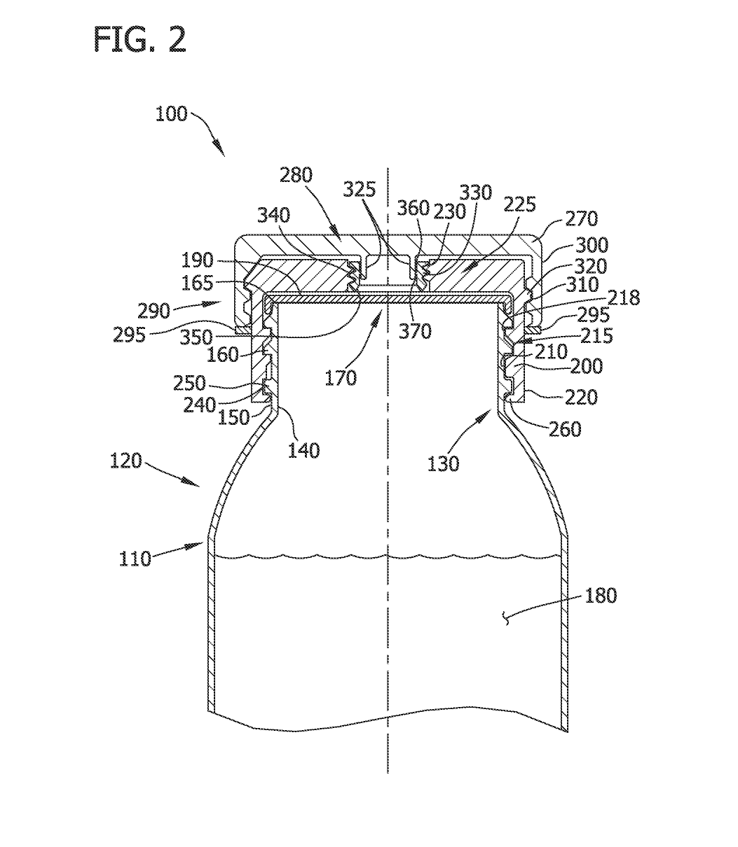

A substantially cylindrical cap member 270 is configured to be placed over stationary member 200. Substantially cylindrical cap member 270 includes a top 280 and a cylindrical sidewall 290 that extends downward from an outer circumference of top 280. In one embodiment, an outer surface 300 of sidewall 290 includes knurling 295 (FIG. 2), which may improve gripping of cap member 270 during opening or closing rotation of cap member 270. As used herein, “knurling” refers to one or more of mechanical roughening, ribbing, scalloping, grooving, other texturing techniques and combinations thereof, that may improve gripping by a user. Inner surface 310 of sidewall 290 includes a set of threads configured to engage with threads 320 on outer surface 220 of stationary member 200. In operation, a user may rotate cap member 270 in a closing direction until cap member 270 tightly seals against stationary member 200 for re-sealing after initial opening of cap member 270. In one embodiment, a tamper evident band 295 secures to the cap member 270 to the stationary member 200 by one or more frangible bridges that break upon initial opening of the cap member 270.

In one embodiment, one or more prongs 325 project downward from a central region of a lower surface of top 280. In the exemplary embodiment, there are an opposing pair of prongs 325. Prongs 325 may be integrally molded with top 280 or subsequently attached, such as by mechanical coupling, sonic welding or by use of an adhesive.

A cutting member 330 includes a set of threads 340 on an outer surface thereof. In the exemplary embodiment, cutting member is generally a hollow cylindrical shape having an open top and bottom. Threads 340 are configured for engagement with second set of threads 230 of second portion 225 of stationary member 200. In the exemplary embodiment, threads 340 are threaded in a reverse direction to threads 320. Cutting member 330 includes one or more cutting projections 350. Cutting projections 350 may be blade shaped, double beveled, single beveled or otherwise include a sharpened edge suitable for cutting sealing membrane 190. In one embodiment, cutting member 330 includes one or more engagement members 360 projecting radially inward from an inner surface of cutting member 330. Engagement members 360 may be squared or ramp shaped projections. In one embodiment, engagement members 360 are configured to engage with projections 370 that project radially outward from prongs 325. In yet another embodiment, prongs 325 directly engage with engagement members 360, without the use projections 370. In another embodiment, prongs 325 taper radially outward in a downward direction, such that as they are raised upward, a tight frictional engagement occurs with the inner surface of cutting member 330.

In operation, container 110 is filled with a substance 180 and subsequently sealed with sealing member 190. Such sealing may include hermetically or aseptic sealing. Stationary member 200 is placed over neck 130 and is turned in a closing direction. Threads 160 and 218 cooperate such that stationary member 200 is drawn downward. As stationary member 200 is drawn downward, ratchet member 240 engages locking protrusion 250, to provide an anti-backoff mechanism. Stationary member may be turned until flange 260 is positioned below locking protrusion 250. In one embodiment, when stationary member 200 is tightly secured on neck 130, second portion 225 presses sealing membrane 190 tightly against rim 165. Cutting member 330 may then be threaded into stationary member 200, alternatively cutting member 330 may be threaded into stationary member 200 before stationary member 200 is coupled to neck 130. In yet another embodiment, cutting member 330 is initially provided on cap member 270, and threaded onto stationary member together with cap member 270. In still another embodiment, stationary member 200, cutting member 330 and cap member 270 are threaded together as an assembly, and subsequently the assembly is threaded onto neck 130.

Cap member 270 is placed over stationary member 200 such that threads 310 engage threads 320. Cap member 270 is turned in a closing direction, which draws cap member 270 downward. In one embodiment, threads 310, 320, 210 and 160 are threaded in the same direction such that turning cap member 270 in a closing direction also turns stationary member 200 in a closing direction. In an embodiment that cutting member 330 has been threaded to stationary member 200 prior to cap member 270 being threaded to stationary member 200, prongs 325 are inserted through a top opening of cutting member 330 before threading cap member 270 onto stationary member 200. Cap member 270 may be threaded onto stationary member such that a lower surface of top 280 presses against an upper surface of second portion 225 of stationary member 200, which may provide a secondary sealing function for bottle 110 in addition to, or in place of, sealing membrane 190. When in an initial sealed state (i.e., before sealing membrane 190 has been punctured), cutting member 330 is disposed above sealing membrane 190 such that cutting projections do not pierce sealing membrane 190. FIG. 2 shows a perspective view of cap member 270 coupled to bottle 110.

To access the contents of the container 110, a user rotates cap member 270 in an opening direction, (e.g., counterclockwise). Rotation of cap member 270 in the opening direction draws cap member upwardly. During rotation of cap member 270, prongs 325 engage cutting member 330 and initiate rotation of cutting member 330 in the same direction as cap member 270. Because threads 230 are threaded opposite to threads 320, cutting member 330 is drawn downward (i.e., in an opposite vertical direction) during opening rotation of cap member 270. As cutting member moves downward, cutting projections pierce sealing membrane 190, and rotation of cutting member 330 causes cutting projections to cut an arc in sealing membrane 190. In one embodiment, cutting member 330 is configured such that cutting projections 250 only cut a partial arc (i.e., less than 360 degrees), such that the cut portion of sealing membrane 190 remains attached to the remaining portion of sealing membrane 190. In this manner, the cut portion is in the form of a flap, and is pushed downward and radially outward by cutting member 330 during initial opening. For example, as cap member 270 moves upward, the prongs release from the cutting member 330 just before the sealing membrane 190 is cut a full 360 degrees. Once the sealing membrane 190 has been cut, the user may access substance 180, for example by pouring the contents through the cut section in the sealing membrane 190.

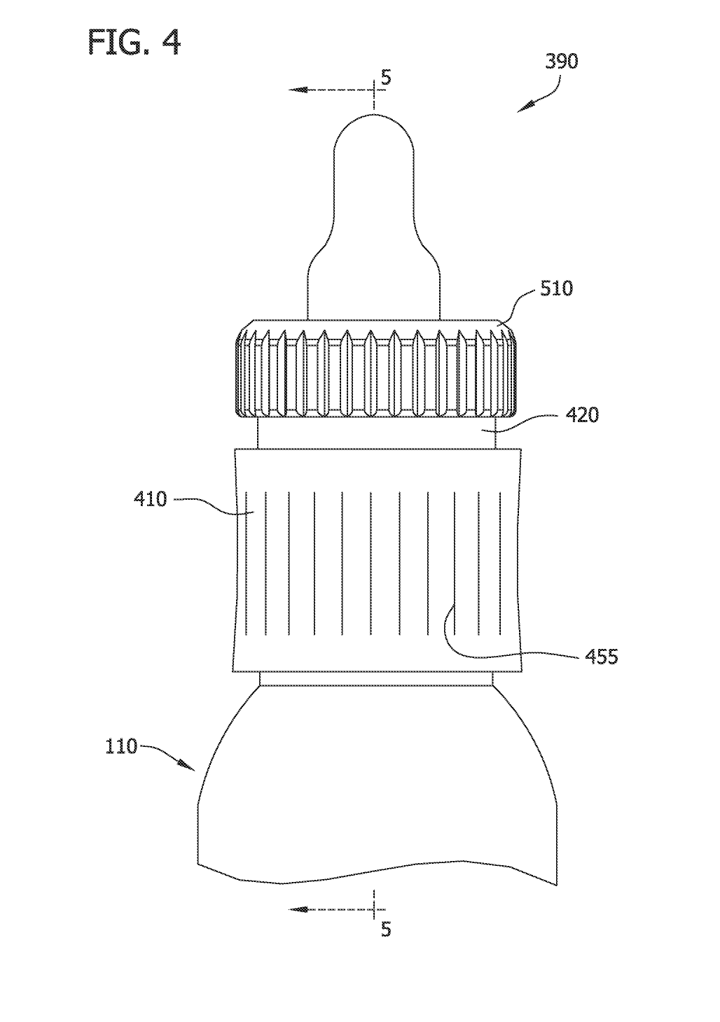

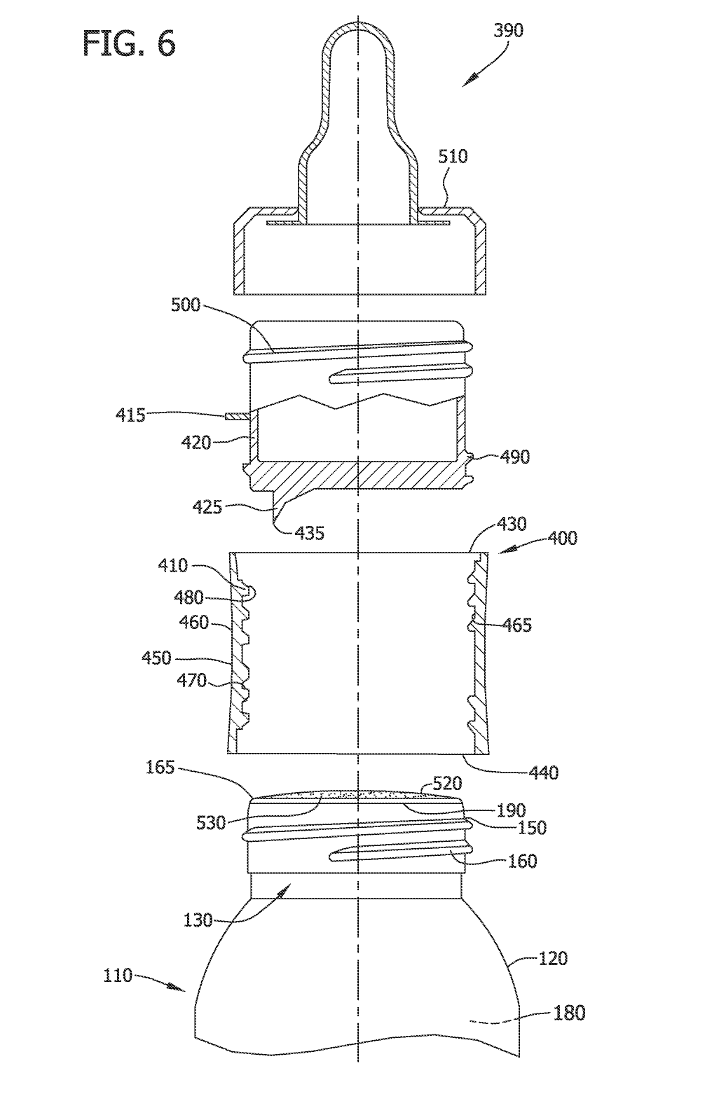

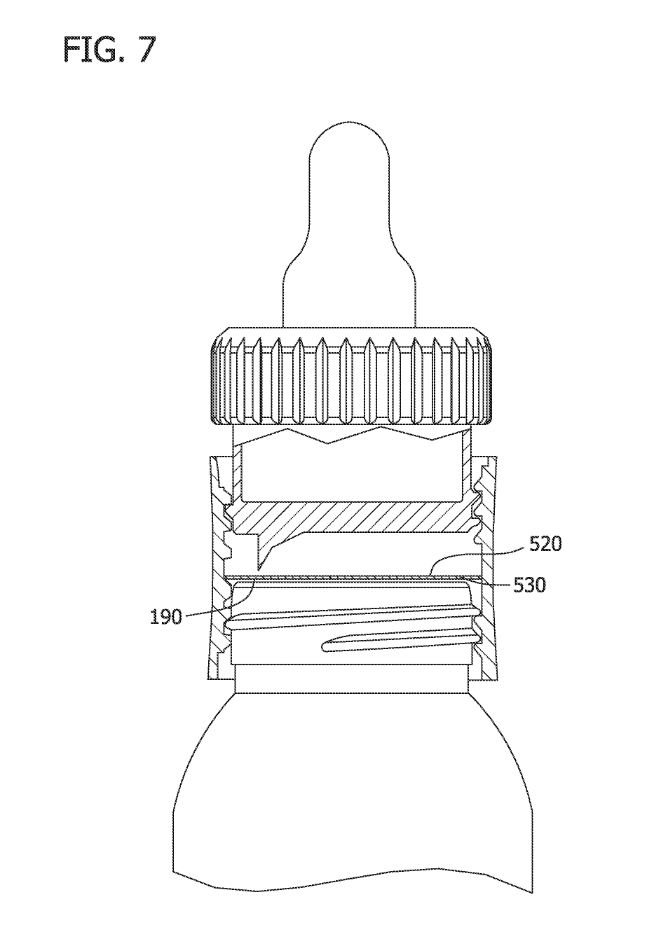

FIGS. 4-7 show another embodiment of a cutting and dispensing closure 390 for a container 110 according to the present disclosure. Similar elements among the figures are referred to by like reference numerals. In this embodiment, container 110 comprises a body 120 and a neck 130. Neck 130 has an outer surface 150 that includes a set of threads 160. Set of threads 160 may include one or more threads that helically wrap around outer surface 150. Container 110 may contain a substance 180. In the exemplary embodiment, closure 400 includes a cylindrical body member 410 and a cutting member 420. Body member 410 is generally cylindrical in shape and has an open upper end 430 and an open lower end 440. A cylindrical sidewall 450 is defined between upper end 430 and lower end 440. Cylindrical sidewall 450 may include knurling 455 on its outer surface 460 for improving grip by a user. Inner surface 465 of cylindrical sidewall 450 includes a first set of threads 470 and a second set of threads 480. In the exemplary embodiment, first set of threads 470 are configured to engage threads 160 of container 110. Second set of threads 480 are configured to engage threads 490 of cutting member 420.

Cutting member 420 includes a second set of threads 500 disposed above threads 490 for threadably coupling a cap member 510 thereto. Cutting member 420 includes one or more cutting projections 425 extending downward from a lower surface of cutting member 420. Cutting projection 425 may be blade shaped, double beveled, single beveled or otherwise include a sharpened edge suitable for cutting sealing membrane 190. Cutting projection 425 may include a small point 435 disposed at a lowermost portion thereof for piercing sealing membrane 190. Cap member 510 may be a nipple, closure cap, enteral feeding adapter or the like. Cap member 510 may include a nipple (or other adapter) formed integrally therewith, or in other embodiments, cap member 510 may be a cap for placing a nipple therethrough and initially provided with a dust cover, such as a sealing film, provided over the opening for the nipple or other adapter. In such embodiment, a consumer may remove the dust cover and connect the nipple or other adaptor to cap member 510 at the time of use. In another embodiment, cap member 510 is fixedly coupled, or integral with, cutting member 490.

In the exemplary embodiment, bottle 110 is sealed with a sealing membrane 190. Sealing membrane 190 may be coupled to rim 165 by way of an adhesive, sonic welding, heat sealing or any other manner of sealing that allows the closure to function as described herein. In one embodiment, a stopper 415 prevents cutting member 420 from unintended opening rotation. Stopper 415 may be connected to at least one of cutting member 420 and body member 410 by a frangible connection such that upon initial opening rotation of cutting member 420, the frangible member breaks allowing rotation of the cutting member 420. In other embodiments, stopper 415 may be a circumferential tamper evident band or the like.

In operation, bottle 110 is provided with substance 180 therein and sealed using sealing membrane 190. Cylindrical body member 410 is then threaded onto bottle 110 by way of threads 470 engaging threads 460 and rotating cylindrical body member 410 in a closing direction. Rotating cylindrical body member 410 in the closing direction draws cylindrical body member 410 downward. Cutting member 420 is threaded into cylindrical body member 410 by way of second set of threads 480 engaging threads 430, and rotating cutting member 420 in the closing direction. Cap member 510 may be threaded onto cutting member 420 before or after cutting member 420 is threaded into cylindrical body member 410. Upon sufficient closing rotation of cutting member 420, cutting projection 425 pierces sealing membrane 190, and further rotation causes cutting projection 425 to cut an arc in sealing membrane 190. In one embodiment, cutting member 420 is configured such that cutting projections 425 only cut a partial arc (i.e., less than 360 degrees) in sealing membrane 190, such that the cut portion of sealing membrane 190 remains attached to the remaining portion (i.e., the peripheral edge) of sealing membrane 190. In this manner, the cut portion of sealing membrane 190 is in the form of a flap, and is pushed downward and radially outward by cutting member 420 during initial opening.

In another embodiment, a second membrane 520 is disposed adjacent sealing membrane 190. Second membrane 520 may be in the form of a pouch, pillow packet or the like. In the exemplary embodiment, second membrane 520 contains a additive 530 to be added to substance 180. Additive 530 may be a component that is reactive with other substances, including air or oxygen, such that it is desirable to keep additive 530 separate from substance 180. In some exemplary embodiments, additive 530 may be a probiotic, prebiotic, vitamin, mineral, long chain polyunsaturated fatty acid, medicine, colorant, flavoring, catalyst or the like. In this embodiment, when a user rotates cutting member 420 in the closing direction, cutting projection 425 will cut both sealing membrane 190 and second membrane 520, releasing additive 530 into substance 180. In another embodiment, cutting member 330 (shown in FIG. 2) is configured to cut both sealing membrane 190 and second membrane 520, releasing additive 530 into substance 180. Substance 180 and additive 530 may be mixed by shaking, stirring or the like.

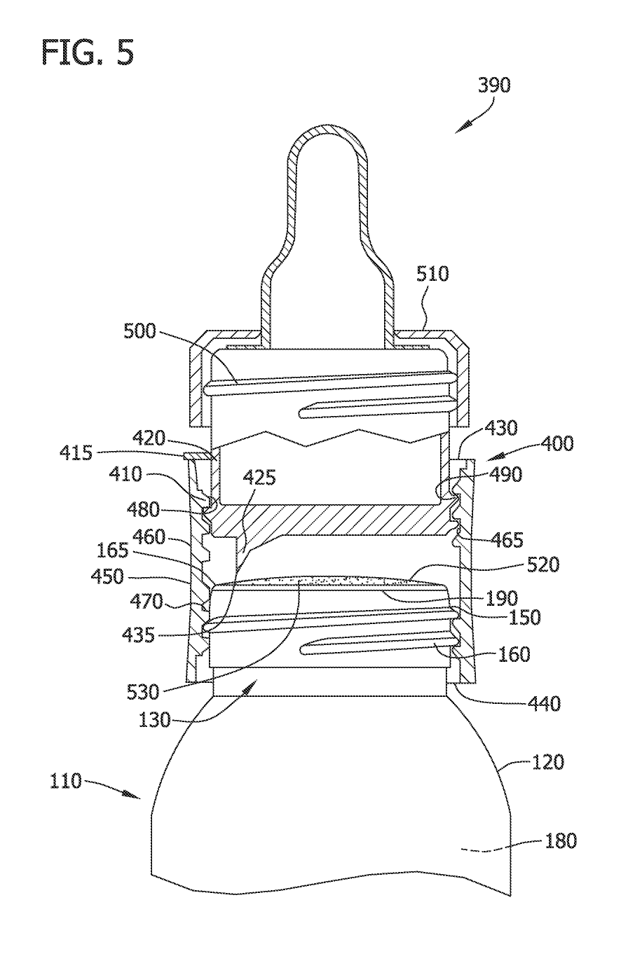

In another embodiment, as shown in FIG. 5, second membrane 520 is a single layer formed adjacent sealing membrane 190 such that a open space for containing additive 530 is defined between sealing membrane 190 and second membrane 520. In yet another embodiment, additional layers of second membrane may be included to contain additional additives.

FIG. 4 shows a perspective view of the cutting and dispensing closure 390, including cylindrical body member 410, cap member 510 and cutting member 420 in an assembled state on container 110.

In some embodiments, one or more elements of closures 100 or 390 and container 110 may be fabricated from plastic, such as a substantially transparent plastic material. For example, substantially cylindrical cap member 270 may be fabricated from the substantially transparent plastic material, thereby allowing a user the ability to view whether sealing membrane 190 has been punctured before removal of cap member 270, thus providing a tamper evidence feature. In other embodiments, one or more elements of closures 100 or 390 or container 110 are fabricated from substantially opaque materials, thus preventing light from entering container 110, and possibly degrading substance 180. One or more elements of closures 100 or 390 and container 110 may be made from a suitable plastic, such as high density polyethylene, polypropylene or other suitable plastics, or may be made from other materials such as paper, various resiliently flexible laminates and other suitable resiliently flexible materials without departing from the scope of the present invention. High density polyethylene, for example, can be formed to be suitably resiliently flexible and to allow for generally resilient deformation when a pressure is applied in a radially inward direction. The container 110 can be molded, such as by blow molding, or formed in other ways without departing from the scope of the present invention.

In another embodiment, container 110 may be generally resiliently deformable when a pressure is applied in a radially inward direction (i.e., toward the axis C). By being resiliently deformable, the container 110 resists denting and other physical defects which may occur during shipping and storage. Moreover, a user may more readily “squeeze” the container 110 with his or her hand, causing the container to resiliently deform. In one embodiment, the resiliency of the container facilitates easier removal of the substance 180 from the container upon squeezing of container 110. Providing such resiliency of the container 110 may also enhance the user's grip on the container. When the user releases the container 110, the sidewall thereof will substantially rebound to its original shape, without denting, creasing, or other permanent and readily visible deformation.

As used herein, the terms “closing rotation” and “opening rotation” refer to clockwise or counterclockwise rotation of an element with respect to another element. In one non-limiting example, for right-handed threads, closing rotation refers to clockwise rotation and opening rotation refers to counterclockwise rotation. In another non-limiting example, for left-handed threads, closing rotation refers to counterclockwise rotation and opening rotation refers to clockwise rotation. As one of skill in the art will appreciate, the orientations of the threads in the embodiments discussed herein can be switched if desired so long as the relationships described herein are preserved, thus allowing the closures to function as described herein.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1-15. (canceled)

16. A closure for a container, comprising:
a stationary member having an inner surface and an outer surface, the inner surface configured to be secured to an outer circumference of a neck of the container at a first inner portion and including a second inner portion having a second set of screw threads, the outer surface comprising a third set of screw threads;
a substantially cylindrical cap member including a top wall and a sidewall that extends downward from an outer circumference of the top wall, the sidewall including sidewall threads for rotational engagement with the third set of screw threads of the stationary member; and
a cutting member comprising an outer set of threads located on an outer circumference of the cutting member and an engagement member located on an inner circumference of the cutting member;
wherein the cylindrical cap is configured to move the cutting member in an opposite longitudinal direction to the cylindrical cap upon application of an opening rotation to the cylindrical cap;
wherein the stationary member is coupled to the container via a ratcheting member that engages a locking projection of the container.

17. The closure according to claim 16, wherein the cutting member comprises one or more cutting projections configured to cut a sealing membrane of the container.

18. The closure according to claim 16, wherein the cylindrical cap comprises a pair of opposing prongs projecting downward from a central portion of an underside of the cap, the prongs configured to engage with the cutting member and rotate the cutting member upon the application of the opening rotation of the cylindrical cap.

19. The closure according to claim 18, wherein the cutting member is configured to cut the sealing membrane such that a cut portion of the sealing membrane remains at least partially connected to a remainder of the sealing membrane upon removal of the cap.

20. The closure according to claim 18, further comprising a tamper evident band secured to the cap and the stationary member by one or more frangible bridges.

21. The closure according to claim 16, wherein the second inner portion of the stationary member is shaped to at least be partially disposed radially inward of the neck of the container.

22. The closure according to claim 16, wherein the cutting member comprises a second set of threads for attaching a cover cap.

23. A closure for a container having a threaded neck, the closure comprising:
a first sealing membrane for sealing an open end of a container;
a second membrane, adjacent the first sealing membrane, containing an additive to be added to the container;
a cylindrical body member having a first end, a second end opposite the first end, an inner surface and an outer surface, the inner surface including a set of screw threads, the first end and second end being open; and
a cutting member having a first set of threads on its outer surface, and configured for threaded engagement with the inner surface of the cylindrical body member;
wherein the cutting member is configured to cut the first sealing membrane and the second membrane upon rotation of the cutting member;
wherein the cutting member comprises a second set of threads for attaching a cover cap.

24. The closure according to claim 23, wherein the cover cap is a nipple.

25. The closure according to claim 23, wherein the second membrane comprises a pouch containing the additive.

26. The closure according to claim 23, wherein the substance is contained between the first sealing membrane and the second membrane.

27. The closure according to claim 23, wherein the cutting member comprises a cutting projection extending from a lower surface of the cutting member.

28. The closure according to claim 27, wherein the piercing member is configured to only partially cut the first membrane and the second membrane such that each of the first membrane and the second membrane remain attached to the container after being cut.

29. The closure according to claim 23, wherein the additive is one or more of a probiotic, prebiotic, vitamin, medicine, colorant, flavoring or catalyst.

30. The closure according to claim 23, wherein the cutting member is configured to hold at least one of the first sealing membrane and the second membrane against a neck of the container after the first membrane and the second membrane have been cut.
